(19) United States
(12) Patent Application Publication
(10) Pub. No.: US 2026/0089080 A1
(43) Pub. Date: Mar. 26, 2026

(54) COMMUNICATING WITH A DUT USING PROTOCOL-AGNOSTIC CIRCUITRY

(71) Applicant: Teradyne, Inc., North Reading, MA (US)

(72) Inventors: Jason Messier, Winchester, MA (US); Gregory C. Warwar, Moorpark, CA (US); Jeffrey Benagh, Melrose, MA (US)

(73) Assignee: Teradyne, Inc., North Reading, MA (US)

(21) Appl. No.: 18/894,580

(22) Filed: Sep. 24, 2024

(51) Int. Cl. H04L 43/12; H04L 25/49; H04L 43/50; H04L 69/18

(52) U.S. Cl. CPC H04L 43/12; H04L 25/4917; H04L 43/50; H04L 69/18

(57) ABSTRACT

An example apparatus is configured to electrically connect to a device under test (DUT). The apparatus includes a first interface circuit to communicate with a test instrument using a first protocol and a second interface circuit to receive signals containing data from the DUT having a second protocol. The second interface circuit is configured to oversample the signals containing data in voltage and time to produce sampled data. Oversampling includes sampling the signals containing data at a rate that is higher than the Nyquist rate. Circuitry is configured to receive the sampled data from the second interface circuit, to generate the data having the first protocol based on the sampled data, and to output the data having the first protocol to the test instrument via the first interface circuit.

### TECHNICAL FIELD

This specification describes example implementations of techniques for communicating with a device under test (DUT) using protocol-agnostic circuitry.

### BACKGROUND

A test system is configured to test the operation of a device. A device tested by a test system is referred to as a device under test (DUT). Signal frequency attenuation can be an issue when testing a DUT. Signal frequency attenuation may be a function of the distance between the DUT and the test system. For example, signal frequency attenuation may increase at greater distances between a test instrument and the DUT. This can affect the accuracy of the testing performed on the DUT.

### SUMMARY

An example apparatus is configured to electrically connect to a device under test (DUT). The apparatus includes a first interface circuit to communicate with a test instrument using a first protocol and a second interface circuit to receive signals containing data from the DUT having a second protocol. The second interface circuit is configured to oversample the signals containing data in voltage and time to produce sampled data. Oversampling includes sampling the signals containing data at a rate that is higher than the Nyquist rate. Circuitry is configured to receive the sampled data from the second interface circuit, to generate the data having the first protocol based on the sampled data, and to output the data having the first protocol to the test instrument via the first interface circuit. The apparatus may include one or more of the following features, either alone or in combination.

The rate of sampling may be two or more times the Nyquist rate. The rate of sampling may be less than a predefined threshold rate of sampling.

Oversampling may include quantizing the voltage of the data at more thresholds than an encoding modulation of the data. The data having the first protocol may include a first payload and the sampled data may have a greater number of bits than the first payload due to the oversampling.

The circuitry may include one or more of a microprocessor, a digital signal processor, programmable logic, or analog-to-digital converters. The apparatus may be part of a probe card configured to electrically connect to electrical pins on the DUT. The apparatus may be part of a needle of a probe card configured to electrically connect to an electrical pin on the DUT. The apparatus may include a switch configured to connect to a parametric measurement unit (PMU) configured to measure properties of a signal. The apparatus may include the PMU.

The apparatus may be or include a package. The package may include a first silicon module including the first interface, the second interface, the circuitry, and the switch; and a second silicon module including the PMU.

The data may include multi-level data. The second protocol may include at least one of the PAM3 (pulse-amplitude modulation 3) protocol, the PAM4 (pulse-amplitude modulation 4) protocol, or the PAM7 (pulse-amplitude modulation 7) protocol. The first protocol may address a frequency attenuation that is greater than an attenuation that second protocol addresses.

The second interface circuit may be configured to obtain digital data from the circuitry and to convert the digital data to analog signals for output to the DUT.

An example system includes an apparatus configured to electrically connect to a device under test (DUT). The apparatus includes a first interface circuit to communicate with a test instrument using a first protocol and a second interface circuit to receive signals containing data from the DUT having a second protocol. The second interface circuit is configured to oversample the signals containing data in voltage and time to produce sampled data. Oversampling includes sampling the signals containing data at a rate that is higher than the Nyquist rate. Circuitry is configured to receive the sampled data from the second interface circuit, to generate the data having the first protocol based on the sampled data, and to output the data having the first protocol to the test instrument via the first interface circuit. The system includes the test instrument. The test instrument includes an arbitrary waveform generator (AWG) to transmit data having the first protocol to the first interface.

The system may include one or more processing devices configured to reconstruct at least some of the data having the second protocol received from the DUT at the second interface based on the data having the first protocol received at the test instrument via the first interface. The one or more processing devices may be configured to reconstruct at least some of data having the second protocol received from the DUT at the second interface while the circuitry performs oversampling on other signals containing data having the second protocol received from the DUT at the second interface.

The test instrument may be configured to adjust a phase of sampling. The test instrument may be configured to adjust a rate of the sampling. Adjusting the rate may include sampling signals containing data having the second protocol at a first rate, obtaining information including timing information based on the sampling at the first rate, and then sampling signals containing data having the second protocol at a second rate, the second rate being less than the first rate.

An example method performed is by an apparatus configured to electrically connect to a device under test (DUT). The apparatus includes (i) a first interface circuit to communicate with a test instrument using a first protocol, and (ii) a second interface circuit to communicate with the DUT using a second protocol. The method includes receiving, at the second interface circuit, signals containing data from the DUT, where the data has the second protocol; oversampling signals containing the data in voltage and time to produce sampled data, where oversampling includes sampling the data at a rate that is higher than the Nyquist rate; generating data having the first protocol based on the sampled data; and outputting the data having the first protocol to the test instrument via the first interface circuit. The method may include one or more of the following features, either alone or in combination.

Oversampling may include quantizing the voltage of the data at more thresholds than an encoding modulation of the data. The rate of sampling may be two or more times the Nyquist rate. The data having the first protocol may include a first payload and the sampled data may have a greater number of bits than the first payload due to the oversampling. The method may include adjusting the phase of sampling. The method may include adjusting a rate of the sampling. Adjusting the rate of the sampling may include sampling signals containing data having the second protocol at a first rate, obtaining information including timing information based on the sampling, and then sampling signals containing data having the second protocol at a second rate. The second rate may be less than the first rate. The method may include adjusting quantization levels associated with the sampling.

The first protocol may address a frequency attenuation that is greater than a frequency attenuation that the second protocol addresses. The data may be or include multi-level data. The second protocol may include at least one of the PAM3 (pulse-amplitude modulation 3) protocol, the PAM4 (pulse-amplitude modulation 4) protocol, or the PAM7 (pulse-amplitude modulation 7) protocol. The second interface circuit may obtain digital data and convert digital data to analog signals for output to the DUT.

Any two or more of the features described in this specification, including in this summary section, may be combined to form implementations not specifically described in this specification.

At least part of the devices, systems, circuits, and processes described in this specification may be configured or controlled by executing, on one or more processing devices, instructions that are stored on one or more non-transitory machine-readable storage media. Examples of non-transitory machine-readable storage media include read-only memory, an optical disk drive, memory disk drive, and random access memory. At least part of the devices, systems, circuits, and processes described in this specification may be configured or controlled using a computing system comprised of one or more processing devices and memory storing instructions that are executable by the one or more processing devices to perform various control operations. The devices, systems, circuits, and processes described in this specification may be configured, for example, through design, construction, composition, arrangement, placement, programming, operation, activation, deactivation, and/or control.

The details of one or more implementations are set forth in the accompanying drawings and the following description. Other features and advantages will be apparent from the description and drawings, and from the claims.

### DESCRIPTION OF THE DRAWINGS

FIG. 1 is a block diagram of an example test system.

FIG. 2 is a block diagram of an example configuration of components of the example test system.

FIG. 3 is a block diagram of another example configuration of components of the example test system.

FIG. 4 is a flowchart showing example operations included in an example process for generating data to send to a test instrument using oversampled data.

FIG. 5 is a flowchart showing example operations included in an example process that includes calibrating circuitry used to perform oversampling.

Like reference numerals in different figures indicate like elements.

### DETAILED DESCRIPTION

Described herein are examples of systems and processes for communicating with a device under test (DUT) to test the DUT. The DUT may be any type of electronic device such as, but not limited to, a microprocessor, a graphics processing unit (GPU), or a radio frequency (RF) transceiver configured to implement wireless communications such as cellular, WiFi, Bluetooth, or GPS (global positioning system) functionality.

The example systems and processes communicate with the DUT using a long-haul connection and a short-haul connection, with circuitry to convert between the two. The long-haul connection may be on the order of single-digit meters or more (for example, one meter or more). The short-haul connection may be on the order of double-digit centimeters or less (for example, 30 centimeters (cm) or less) or single-digit centimeters or less (for example 5 cm or less, 4 cm or less, 3 cm or less, 2 cm or less, or 1 cm or less).

In some examples, the long-haul connection uses a communication protocol and includes equalization or other processing to produce a high-bandwidth link between the DUT and the test instrument, thereby addressing frequency attenuation in signals that may occur over long-haul connections and allowing data to be transferred over the long haul connection with a relatively low frequency attenuation. Frequency attenuation includes a loss of signal strength. In some examples, a relatively low frequency attenuation enables a bit error rate (BER) of 10⁻¹⁵ or less. In some examples, in this context, a relatively large frequency attenuation is at least an order of magnitude greater than a relatively small frequency attenuation.

In some examples, the short-haul connection does not include such equalization or other processing; however, due to the relatively short distance, frequency attenuation does not have a considerable deleterious effect on the data, resulting in BERs on the short-haul connection that are comparable to, or better than, the BERs of the long-haul connection. As such, protocols used over short-haul connections may have relatively few or no features designed to address frequency attenuation.

Different protocols may be used to transmit the data over the long-haul connection and the short-haul connection. For example, protocols configured for connections that, absent use of such protocol(s), would produce relatively large frequency attenuations may be used for communications over a long-haul connection. Protocols associated with (e.g., that address) relatively large frequency attenuations include, but are not limited to, one or more of the following protocols: PCIe5/6 (peripheral component interconnect express) and Ethernet. For example, protocols configured for connections having relatively small frequency attenuations may be used for communications over a short-haul connection. Protocols associated with relatively small frequency attenuation include, but are not limited to, one or more of the following protocols: the mobile industry processor interface (MIPI®) protocol, the common flash interface (CFI) protocol, the DFI (DDR PHY Interface) protocol, the MFI (made for iPhone®/iPod®/iPad®) protocol, the UCIe (universal chiplet interconnect express) protocol, and/or one or more RF protocols.

The frequency attenuation over the long-haul connection may be based on an S21 parameter associated with the test instrument and the frequency attenuation over the short-haul connection may be based on an S21 parameter associated with the DUT.

The c-phy v2.1 standard has a channel mask that tolerates an S21 parameter of −4.85+/−0.55 dB (decibels) at 5 Ghz (gigaherz). The S21 parameter of a channel going directly to test equipment has an S21 parameter of about −18.1 dB at 5 Ghz. Thus, in some implementations, the maximum baud rate at a reasonable BER is lower than the maximum baud rate allowed using a compliant channel S21.

Circuitry, such as one or more processing devices or programmable logic, is configured to perform conversion between a first protocol that is used for communication to and from the test instrument over the long-haul connection and a second protocol, which is different from the first protocol, that is used for communication to and from the DUT over the short-haul connection. The circuitry thus may enable communications directly to the DUT to be implemented without the equalization or other processing required for long-haul connections and protocols. The circuitry also may enable communications directly to the DUT in protocol(s) actually used by the DUT for short-range, lower frequency-attenuation, communications.

The circuitry may be protocol agnostic. For example, the circuitry may be protocol agnostic in the sense that the circuity was not designed for a particular protocol, but rather may be configured to handle different protocols. In some examples, the systems and processes described herein is enable communication with a DUT using a protocol that was not known at the time the circuitry was designed and deployed, but that is determined after that time. The protocol-agnostic circuitry can be configured for any DUT physical interface that is within the circuitry's performance capability (e.g., the baud_rate*modulation_depth product).

A physical interface circuit located along a communication path between the circuitry and the DUT may be configured to oversample signals received from the DUT in voltage and time to produce sampled data, where oversampling includes sampling the signals at a rate that is higher than the Nyquist rate. In this regard, the data is transmitted as a continuous-time signal and sampling produces digitized information by identifying values of the signal at predefined voltages and times. The oversampling produces an amount of sampled data that allows the information communicated from the DUT to be identified and formatted by the circuitry to convey that information, with little or no loss, to the test system. For example, the data, when formatted in the first protocol, may include a first payload and the same oversampled data may have a greater number of bits than the first payload due to the oversampling.

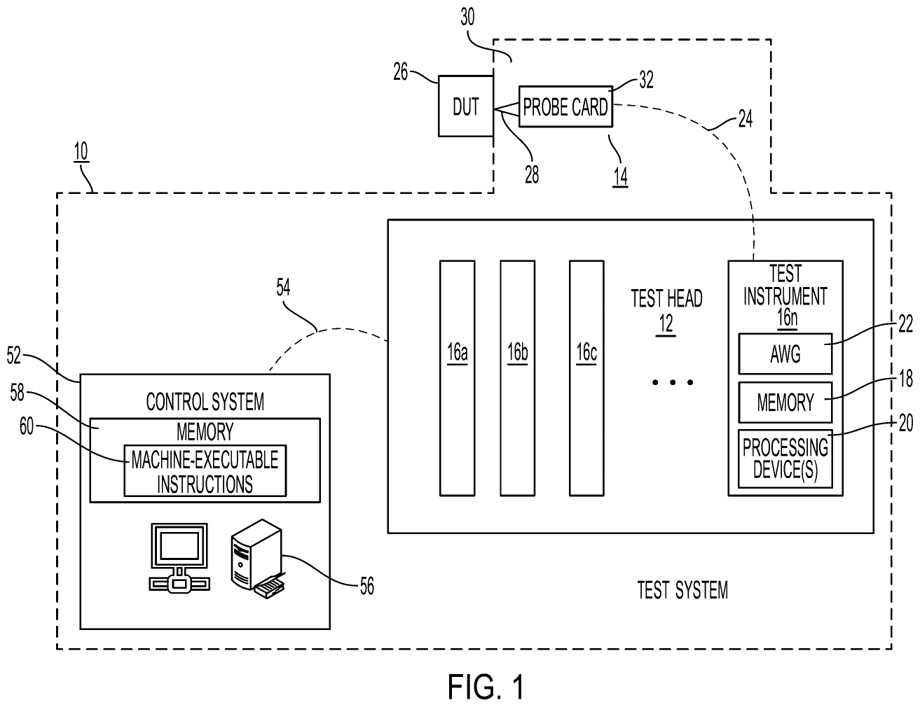

FIG. 1 is a block diagram showing example components of example test system 10, which may be automatic test equipment (ATE), that may be used to implement all or part of the systems and processes described herein. Test system 10 includes a test head 12, which may be in wired or wireless communication with a probe card 14.

In this example, test head 12 includes multiple test instruments 16a to 16n (where n>3), each of which may be configured, as appropriate, to implement testing as described herein and/or other functions. Although only four test instruments are shown, test system 10 may include any appropriate number of test instruments, including one or more residing outside of test head 12. The test instruments may be hardware devices that each may include memory 18, one or more processing devices 20, an automatic waveform generate (AWG) 22 and/or other circuitry (not shown). These components are illustrated only on test instrument 16n.

The test instruments may be configured—for example, programmed—to generate and to output test signals containing test data. For example, memory 18 may store instructions for a test program that are executable by processing devices 20 to control AWG 22 to output test signals over long-haul connection 24 over a different path to DUT 26. The test signals may be high-frequency signals, examples of which include signals in the gigabit-per-second range (Gb/s). Long-haul connection 24 may include a wired connection, such as one or more coaxial cables, Ethernet, or other transmission media, and may have lengths and frequency attenuations that produce BERs similar to those described above. Long-haul connection 24 may include a wireless, e.g., RF connection. Long-haul connection 24 may electrically connect to probe card 14, thereby enabling communication between probe card 14 and test instrument 16n.

Only one probe card and DUT are shown in FIG. 1. However, there may be multiple probe cards (not shown) and corresponding DUTs (not shown) connected to one, some, or all of test instruments 16a to 16n. These multiple probe cards may have the same, or different, structure and function as example probe card 14.

Test instrument 16n is also configured to receive signals containing data over long-haul connection 24. The signals may include data based on a DUT 26's response to the test data provided by AWG 22. One or more processing devices 20 on test instrument 16n may be configured to reconstruct at least some of the data having the second protocol received from the DUT at the second interface based on the data having the first protocol received at the test instrument. One or more processing devices 20 on test instrument 16n may be configured to determine if DUT 26 passed or failed testing. For example, one or more processing devices 20 on test instrument 16n may execute instructions from memory 18 to compare the data received from probe card 14 to one or more thresholds and to determine, based on the comparison, whether DUT 26 passed or failed testing. This may be done while the second interface continues to receive signals containing data from the DUT.

Example probe card 14 is physically movable to within double-digit or single-digit centimeters of, or single-digit millimeters of, DUT 26 in order to enable testing of DUT 26. For example, probe card 14 may include a needle 28 configured to contact a pin on DUT 26 to provide test data to that pin and to receive response data from that pin. Needle 28 includes electrically conductive material, such as metal (e.g., copper or aluminum) to create an electrical connection between probe card 14 and DUT 26. Needle 28 may be a MEMS (micro-electromechanical system) probe needle.

Data is sent between the probe card and the DUT over short-haul connection 30 using a protocol designed for signals having relatively low frequency attenuation, examples of which are described herein. Short-haul connection 30 may include a conductive connection, which may be or include needle 28 and/or an electrically conductive portion of needle 28 on probe card 14, and which may have a length and a frequency attenuation that produce BERs similar to those described above. Short-haul connection 30 may include a wireless, e.g., RF connection.

Example probe card 14 may include a substrate 32 in addition to needle 28. Substrate 28 may be a non-conductive material, such as FR-4, and may include circuitry and conductive traces (not shown) to receive and to process data for output over long-haul connection 24 to test instrument 16a.

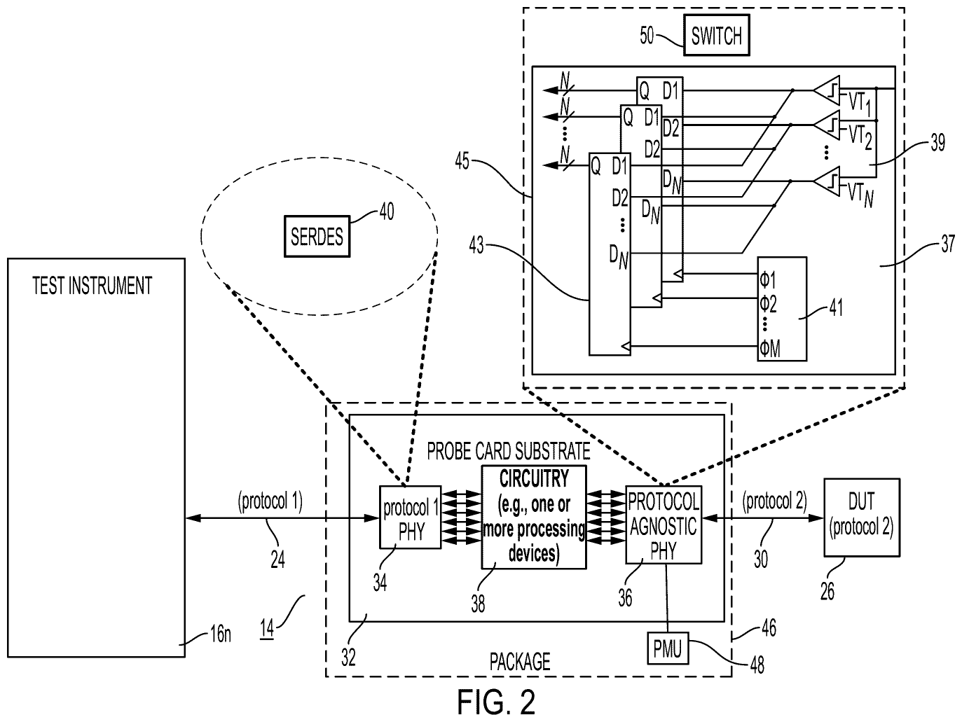

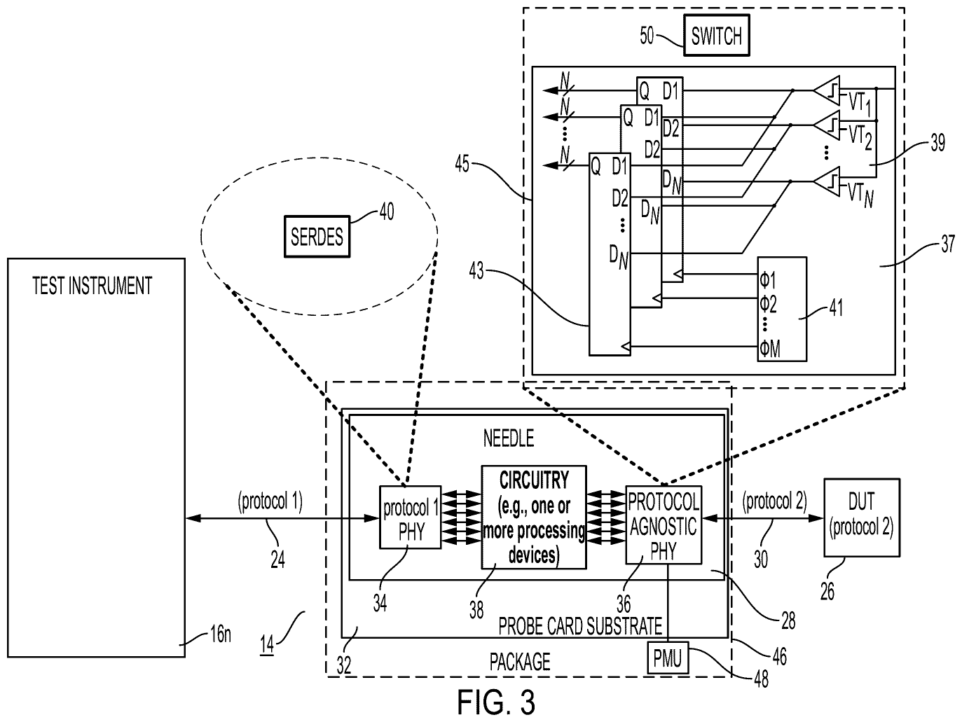

Referring to FIGS. 2 and 3, example probe card 14 includes a first interface circuit 34, a second interface circuit 36, and circuitry 38 to convert data between protocols used by first interface circuit 34 and second interface circuit 36 to communicate, respectively, with test instrument 16n. In the example of FIG. 2, these components are on substrate portion 32 of probe card 14. In the example of FIG. 3, these components may be on a needle portion 28 of probe card 14.

First interface circuit 34 and a second interface circuit 36 may include physical (PHY) interfaces to long-haul connection 24 and short-haul connection 30, respectively. First interface circuit 34 communicates with test instrument 16n over long-haul connection 24. The communications use a protocol, such as those described above, designed for connections that, absent use of such protocol(s), would have relatively large frequency attenuations, which may be due to the relatively long length of the communications medium and/or relatively long distance between first interface circuit 34 and the test instrument 16n.

Second interface circuit 36 communicates with DUT 26 over short-haul connection 30. The communications use a different protocol, such as those described above, designed for connection that have relatively small frequency attenuations, which may be due to the relatively short length of the communications medium and/or relatively short distance between second interface 36 circuit and DUT 26.

Circuitry 38 may include one or more processing devices (e.g., one or more DSPs), one or more instances of programmable logic, and/or one or more solid state electronic devices. Circuitry 38 is configured to convert data to the protocol that is used for communication to and from the test instrument over the long-haul connection. To this end, circuitry 38 is configured to receive data, which is sampled from signals from the DUT, by second interface circuit 32, to generate the data having the first protocol based on the sampled data, and to output the data having the first protocol to the test system via the first interface circuit.

In some implementations, as shown in FIGS. 2 and 3, communications between first interface circuit 34 and test instrument 16n are serial communications; and communications between second interface circuit 36 and DUT 26 are serial communications. First interface circuit 24 may be configured to convert parallel data from circuitry 38 to serial data for output to test instrument 16n. Likewise, second interface second circuit 36 may be configured to convert serial data from DUT 26 to parallel data for processing by circuitry 38. Conversion of serial data to parallel data that is processed by circuitry 38 enables circuitry 38 to process more bits at lower speed than had the data remained in serial form.

In some implementations, first interface circuit 34 includes a serializer/deserializer (serdes) 40. Serdes 40 is configured to receive parallel data from circuitry 38 and to convert that parallel data to serial data in the first protocol for output to test instrument 16n. In some implementations, the serdes may include multiple analog-to-digital converters (ADCs) (not shown).

In some implementations, the first protocol used for communication between test instrument 16n and first interface circuit 34 is a known, or predefined, protocol. For example, circuitry 38 may be configured to format data received from second interface 36 into this first protocol. In examples, circuitry 38 may be designed, programmed, or physically or electrically changed or otherwise configured to perform the formatting. In an example where circuitry 38 includes a processing device or programmable logic, that processing device or programmable logic may be programmed, or reprogrammed, to perform the formatting. In some implementations, the first protocol may be changed, e.g., through reconfiguration such as reprogramming.

In some implementations, the second protocol used for communication between second interface circuit 36 and DUT 26 is new to the circuitry in the sense that the circuitry was not originally configured to process signals in that protocol. Accordingly, circuitry 38 is said to be protocol agnostic. In this case second interface circuit 36 receives signals containing data from DUT 26 in the protocol. The received data may be in the form of analog signals. Second interface circuit 36 is configured to oversample the signals containing data in voltage and time to produce sampled data. Oversampling the signal in time may include detecting voltage values of the analog time at different points in time. Oversampling the signal in voltage may include identifying each time that the signal reaches or exceeds one of multiple voltage thresholds. By oversampling the signals in time, circuitry 38 can implement the clock and data recovery.

In some implementations, oversampling includes sampling signals containing data at a rate that is two or more times higher than the Nyquist rate, e.g., at a rate that is two times higher than the Nyquist rate, at a rate that is three times higher than the Nyquist rate, at a rate that is four times higher than the Nyquist rate, at a rate that is five times higher than the Nyquist rate, or at any rate that is K times higher than the Nyquist rate, where K>2. In some implementations, the rate may be a fractional multiple of the Nyquist rate. In some implementations, the rate of sampling is less than a predefined threshold rate of sampling, which may be programmed into the circuitry or the second interface. The predefined rate may be less than 100 times oversampling, less than ten times oversampling, or less, and may be selected to ensure that unmanageable amounts of data are not produced by the oversampling performed by the second interface circuit. In some implementations, oversampling includes quantizing voltage of the data at more thresholds than an encoding modulation of the data.

As shown in FIGS. 2 and 3, second interface 36 includes examples sampling circuitry 37 to implement the oversampling in voltage and time. The sampling circuitry include analog-to-digital (ADC) circuitry 39 comprised of multiple comparators, phase clock 41, and registers 43. ADC circuitry 39 is configured to oversample the signals containing data from DUT 26 in voltage. For example, the comparators are configured to compare the received signal to different thresholds and to output a value of one (1) or zero (0) based on the comparison, with those values corresponding to data of the signal. The resulting data is stored in registers 43. Phase clock 41 is controlled or programmed to sample the data from registers in time. This may be done by outputting a clock signal to the registers, which causes the registers to output the data from the ADC circuitry onto parallel bus 45. In some implementations the data may be multi-level (e.g., three-level) rather than binary. The circuitry of second interface 36 may be controlled or configured to generate such data. In some implementations, the test instrument 16n configures the comparator voltage thresholds, the phase clock frequency, and the oversample ratio of second interface circuit 36.

In the examples of FIGS. 2 and 3, the signals containing data from the DUT are sampled at multiple (N>1) comparator thresholds. In addition to sampling the signals containing at more than one voltage level, the signals containing are also oversampled in time with an M-Phase clock. An example oversampling factor of M might be in the range of five (5) to eight (8). In a typical application, such as a protocol using PAM4 data, at least three comparators (N=3) would be needed to distinguish four signal levels. In an example, DUT 26 sends data at 5 billion samples per second, which would be a 200 picosecond (ps) symbol period. The comparators may be configured to sample the data at seven (7) voltage thresholds (eight (8) levels). Each sample would thus be a three-bit value. The signals containing from the DUT may be sampled every 40 ps, thus resulting in each symbol being sampled five times, which means that the data in the signals is oversampled five times.

Circuitry 38 is configured to receive the oversampled data from second interface circuit 36, to generate data having the first protocol based on the oversampled data, and to output the data having the first protocol to the test system via first interface circuit 34. In an example, circuitry 38 is configured to format the data into a format of the first protocol to output the data along a parallel bus to first interface circuit 34. First interface circuit 34 then serializes the data and outputs the data to the test instrument. In some implementations, the formatting performed by circuitry 38 may include encoding the data using techniques such as 8 B/10 B encoding or forward error correction (FEC), and using a first-in-first-out buffer to handle a line rate of the first protocol if the line rate of the first protocol is different than the line rate of the oversampled data.

In some implementations, testing may be performed proximate probe card 14. For example, probe card 14 may be packaged 36 with a testing device, such as a parametric measurement unit (PMU) 48. For example, a first silicon module may contain interface circuits 34, 36 and circuitry 38 and a second silicon module may contain PMU 48. These two silicon modules may be packaged together using known packaging techniques such that the two constitute single chip or device.

Second interface circuit 36 may also include transmit circuitry (not shown) to complete transceiver upload data to the DUT. The transmit circuitry may include one or more digital-to-analog converters (DACs) to obtain digital data from circuitry 38 in the second protocol and to convert that digital data to analog signals for output to the DUT.

A switch 50 or other device, which may be part of second interface circuit 36 or between second interface circuit 36 and circuitry 38, may be controllable (e.g., by the test instrument) to route data to the on-board PMU 48 to analyze received test data. Results of the analysis may be sent to the test instrument via second interface circuit 36 or via another communication connection between test instrument 16n and package 46 (not shown).

Referring back to FIG. 1, example test system 10 also includes a control system 52. Control system 52 may be configured—e.g., programmed—to communicate with test instruments 16a to 16n to direct and/or to control testing of DUTs, such as, but not limited to, DUT 26. In some implementations, this communication 54 may be over a computer network or via a direct connection such as a computer bus or an optical medium. In some implementations, the computer network may be or include a local area network (LAN) or a wide area network (WAN).

Control system 52 may be or include a computing system comprised of one or more processing devices 56 (e.g., microprocessor(s)) and memory 58 for storing machine-executable instructions 60 to control operation of test system 10 and/or testing, and/or to execute one or more test programs, and/or to send to one or more of the test instruments 16a to 16n for execution. Control system 52 may also be configured to receive and to process data from test instruments 16a to 16n to determine whether DUT 26 and/or one or more other DUTs (not shown) passed testing. For example, one or more processing devices 56 may execute instructions to compare data from a test instrument to one or more thresholds and to determine, based on the comparison, whether a corresponding DUT passed for failed testing.

In some implementations, the control functionality of the control system is centralized in processing device(s) 56. In some implementations, all or part of the control functionality attributed to control system 52 may also or instead be implemented on one or more test instruments 16a to 16n and/or all or part of the functionality attributed to one or more test instruments 16a to 16n may also or instead be implemented on control system 52. For example, the control system may be distributed across processing device(s) 56 and one or more of test instruments 16a to 16n.

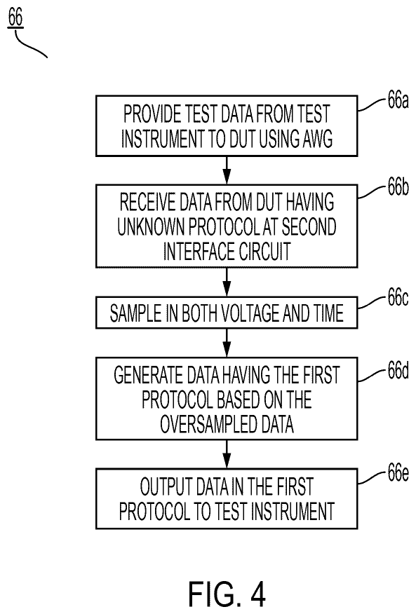

FIG. 4 shows example operations included in an example process 66 that may be performed using the example hardware show in FIGS. 1 to 3. Process 66 may be controlled by control system 52, a test instrument 16n, or control system 52 in combination with one or more of test instruments 16a to 16n.

Process 66 includes providing (66a) test data from test instrument 16n to DUT. The data may be provided to the DUT via the probe card or over another communication path between the test instrument and the DUT not involving the probe card. In some implementations, operation 66a may be omitted. For example, the DUT may generate and output signals that include data to be analyzed by the test instrument without first being prompted by data from the test instrument.

Process 66 includes second interface circuit 36 receiving (66b) signals containing serial data from DUT 26. This data may represent the DUT's reaction to the test data provided by test instrument 16n or data generated autogenously by the DUT. The data may be in an analog signal and in a short-haul protocol, such as one of those described above. Second interface circuit 36 oversamples (66c) the signals containing data in both time and voltage using the example techniques described above to produce oversampled data in digital form. The extent of the oversampling may be as described above, e.g., two or more times the Nyquist rate.

In this example, second interface circuit 36 outputs the oversampled data over a parallel bus to circuitry 38. Circuitry 38 receives the parallel data and converts the parallel data into parallel data having a different protocol—e.g., the long-haul protocol used by test instrument 16n. That is, circuitry 38 generates (66d) data having the first protocol from the oversampled data. Circuitry 38 outputs the converted parallel data to first interface circuit 34. First interface circuit 34 generates serial data in the long-haul protocol based on the converted parallel data and outputs (66e) that serial data in the long-haul protocol to test instrument 16n. In an example, serdes 40 in first interface circuit 34 receives the converted parallel data parallel data and generates the serial data for output to test instrument 16n.

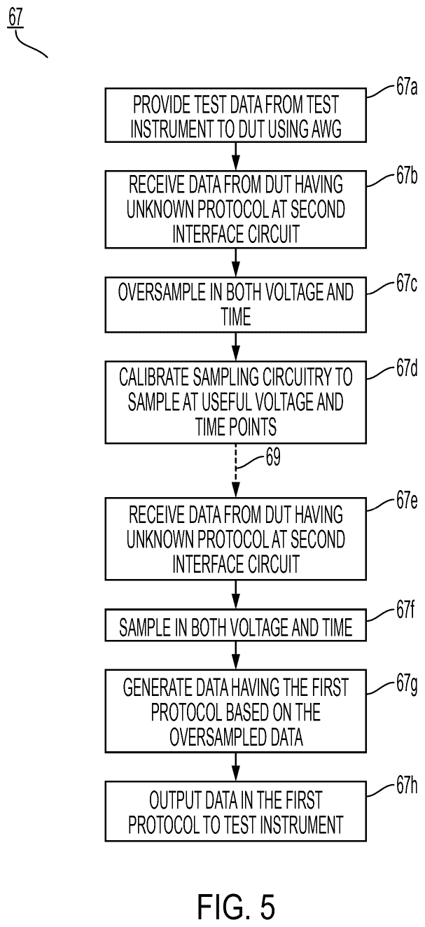

FIG. 5 shows example operations included in an example process 67 that may be performed using the example hardware show in FIGS. 1 to 3. Process 67 may be controlled by control system 52, a test instrument 16n, or control system 52 in combination with one or more of test instruments 16a to 16n.

Operations 67a, 67b, and 67c may be the same as respective operations 66a, 66b, and 66c of FIG. 5. Furthermore, operations 67a, 67b, and 67c may be repeated multiple times (e.g., tens or hundreds of times) using different data from the same DUT (e.g., the same device at each repetition), different data from different instances of the same DUT (e.g., different copies of the same model microprocessor), different data from different types of the same DUT (e.g., microprocessors from two different manufacturers), and/or different data from different types of DUTs (e.g., a microprocessor and a digital signal processor), all of which use the same short-haul protocol for communication. The sampling produces calibration data sets.

Each calibration data set may be analyzed by the control system or test instrument(s) relative to the data that produced the corresponding calibration data set. The control system or test instruments(s) may determine, based on this analysis, what voltages and times in the calibration data sets produced useful data, e.g., data that may be used to recreate the original data and timing from the DUT with little or no loss. The control system or test instruments(s) may calibrate (67d) circuitry 37 so that, going forward, circuitry 37 samples data from DUTs at the useful voltage and time points. The calibration may include programming the comparators with voltage thresholds that capture the useful voltages and programming the phase clock to produce a clock signal that enables sampling of the useful time points. The calibration thus may include adjusting the rate or phase of the sampling by programming the phase clock. The calibration thus may include adjusting the quantization levels associated with sampling. Operations 67e to 67h may be performed at a later time, and with different DUT(s) than operations 67a to 67d, with the dotted line 69 indicating that the two sets of operations do not necessary follow immediately in time.

Operations 67e to 67h are identical to operations 66b to 66e of FIG. 4 except that, in operation 67f, the oversampling is done at the useful voltage and time points calibrated into sampling circuitry 37. The result is that the rate of sampling on signals performed at the useful voltage and time points is less than the rate of sampling that would have occurred on the same signals absent the calibration.

All or part of the systems and processes described herein including but not limited to processes 66 and 67 and variants thereof may be configured and/or controlled at least in part by one or more computers using one or more computer programs tangibly embodied in one or more information carriers, such as in one or more non-transitory machine-readable storage media. A computer program can be written in any form of programming language, including compiled or interpreted languages, and it can be deployed in any form, including as a stand-alone program or as a module, part, subroutine, or other unit suitable for use in a computing environment. A computer program can be deployed to be executed on one computer or on multiple computers at one site or distributed across multiple sites and interconnected.

Actions associated with configuring or controlling the test system and processes described herein can be performed by one or more programmable processors executing one or more computer programs to control or to perform all or some of the operations described herein. All or part of the test systems and processes can be configured or controlled by special purpose logic circuitry, such as, an FPGA (field programmable gate array) and/or an ASIC (application-specific integrated circuit) or embedded microprocessor(s) localized to the instrument hardware.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, such as magnetic, magneto-optical disks, or optical disks.

Non-transitory machine-readable storage media suitable for embodying computer program instructions and data include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

As used herein, the terms “comprises,” “comprising,” “includes,” “including,” “has,” “having,” “contains,” “containing,” and any variations thereof, are intended to cover a non-exclusive inclusion, such that systems, techniques, apparatus, structures, processes, or other subject matter described or claimed herein that includes, has, or contains an element or list of elements does not include only those elements but can include other elements not expressly listed or inherent to such systems, techniques, apparatus, structures, processes or other subject matter described or claimed herein.

All examples described herein are non-limiting.

In the description and claims provided herein, the adjectives “first”, “second”, “third”, and the like do not designate priority or order unless context suggests otherwise. Instead, these adjectives may be used solely to differentiate the nouns that they modify.

Any mechanical or electrical connection herein may include a direct physical connection or an indirect physical connection that includes one or more intervening devices unless context suggests otherwise. A connection between two electrically conductive devices includes an electrical connection unless context suggests otherwise. The signals described herein are electrical signals unless context suggests otherwise.

“Conductive” as used herein refers to electrically conductive unless context suggests otherwise.

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. An apparatus configured to electrically connect to a device under test (DUT), the apparatus comprising:
a first interface circuit to communicate with a test instrument using a first protocol;
a second interface circuit to receive signals containing data from the DUT having a second protocol, the second interface circuit to oversample the signals containing data in voltage and time to produce sampled data, where oversampling comprises sampling the signals containing data at a rate that is higher than the Nyquist rate; and
circuitry to receive the sampled data from the second interface circuit, to generate the data having the first protocol based on the sampled data, and to output the data having the first protocol to the test instrument via the first interface circuit.

2. The apparatus of claim 1, wherein the rate of sampling is two or more times the Nyquist rate.

3. The apparatus of claim 1, wherein oversampling comprises quantizing the voltage of the data at more thresholds than an encoding modulation of the data.

4. The apparatus of claim 1, wherein the data in the first protocol comprises a first payload and the sampled data has a greater number of bits than the first payload due to the oversampling.

5. The apparatus of claim 1, wherein the rate of sampling is less than a predefined threshold rate of sampling.

6. The apparatus of claim 1, wherein the circuitry comprises one or more of a microprocessor, a digital signal processor, programmable logic, or analog-to-digital converters.

7. The apparatus of claim 1, wherein the apparatus is part of a probe card configured to electrically connect to electrical pins on the DUT.

8. The apparatus of claim 1, wherein the apparatus is part of a needle of a probe card configured to electrically connect to an electrical pin on the DUT.

9. The apparatus of claim 1, further comprising:
a switch configured to connect to a parametric measurement unit (PMU) configured to measure properties of a signal.

10. The apparatus of claim 9, further comprising the PMU.

11. The apparatus of claim 9, wherein the apparatus is a package comprising:
a first silicon module comprising the first interface, the second interface, the circuitry, and the switch; and
a second silicon module comprising the PMU.

12. The apparatus of claim 1, wherein the data comprises multi-level data.

13. The apparatus of claim 12, wherein the second protocol comprises at least one of the PAM3 (pulse-amplitude modulation 3) protocol, the PAM4 (pulse-amplitude modulation 4) protocol, or the PAM7 (pulse-amplitude modulation 7) protocol.

14. The apparatus of claim 1, wherein the first protocol addresses a frequency attenuation that is greater than an attenuation that second protocol addresses.

15. The apparatus of claim 1, wherein the second interface circuit is configured to obtain digital data from the circuitry and to convert the digital data to analog signals for output to the DUT.

16. A system comprising:
the apparatus of claim 1;
the test instrument, the test instrument comprising an arbitrary waveform generator (AWG) to transmit data having the first protocol to the first interface.

17. The system of claim 16, further comprising:
one or more processing devices configured to reconstruct at least some of the data having the second protocol received from the DUT at the second interface based on the data having the first protocol received at the test instrument via the first interface.

18. The system of claim 17, wherein the one or more processing devices are configured to reconstruct at least some of data having the second protocol received from the DUT at the second interface while the circuitry performs oversampling on other signals containing data having the second protocol received from the DUT at the second interface.

19. The system of claim 16, wherein the test instrument is configured to adjust a phase of sampling.

20. The system of claim 16, wherein the test instrument is configured to adjust a rate of the sampling.

21. The system of claim 20, wherein adjusting the rate comprises sampling signals containing data having the second protocol at a first rate, obtaining information including timing information based on the sampling at the first rate, and then sampling signals containing data having the second protocol at a second rate, the second rate being less than the first rate.

22. A method performed by an apparatus configured to electrically connect to a device under test (DUT), the apparatus comprising (i) a first interface circuit to communicate with a test instrument using a first protocol, and (ii) a second interface circuit to communicate with the DUT using a second protocol, the method comprising:
receiving, at the second interface circuit, signals containing data from the DUT, the data having the second protocol;
oversampling signals containing the data in voltage and time to produce sampled data, where oversampling comprises sampling the data at a rate that is higher than the Nyquist rate;
generating data having the first protocol based on the sampled data; and
outputting the data having the first protocol to the test instrument via the first interface circuit.

23. The method of claim 22, wherein oversampling comprises quantizing the voltage of the data at more thresholds than an encoding modulation of the data.

24. The method of claim 22, wherein the rate is two or more times the Nyquist rate.

25. The method of claim 22, wherein the data having the first protocol comprises a first payload and the sampled data has a greater number of bits than the first payload due to the oversampling.

26. The method of claim 22, further comprising:
adjusting the phase of sampling.

27. The method of claim 22, further comprising:
adjusting a rate of the sampling.

28. The method of claim 27, wherein adjusting the rate comprises sampling signals containing data having the second protocol at a first rate, obtaining information including timing information based on the sampling, and then sampling signals containing data having the second protocol at a second rate, the second rate being less than the first rate.

29. The method of claim 22, wherein the first protocol addresses a frequency attenuation that is greater than a frequency attenuation that the second protocol addresses.

30. The method of claim 22, wherein the data comprises multi-level data.

31. The method of claim 30, wherein the second protocol comprises at least one of the PAM3 (pulse-amplitude modulation 3) protocol, the PAM4 (pulse-amplitude modulation 4) protocol, or the PAM7 (pulse-amplitude modulation 7) protocol.

32. The method of claim 22, further comprising the second interface circuit obtaining digital data and converting digital data to analog signals for output to the DUT.

33. The method of claim 22, further comprising:
adjusting a quantization levels associated with the sampling.
